(19) United States
(12) Patent Application Publication
(10) Pub. No.: US 2010/0099314 A1
(43) Pub. Date: Apr. 22, 2010

(54) IONIC LIQUIDS DERIVED FROM SURFACTANTS

(76) Inventors: Stacie Ellen Hecht, West Chester, OH (US); Scott Leroy Cron, Fairfield, OH (US); Jeffrey John Scheibel, Loveland, OH (US); Gregory Scot Miracle, Hamilton, OH (US); Kenneth Richard Seddon, Donahadee (GB); Martyn Earle, Belfast (GB); Harambage Quintas Nimal Gunaratme, Belfast (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/581,955

(22) Filed: Oct. 20, 2009

Related U.S. Application Data
(63) Continuation of application No. 11/263,384, filed on Oct. 31, 2005, now abandoned.
(60) Provisional application No. 60/624,056, filed on Nov. 1, 2004.

(51) Int. Cl. C11D 1/65; C11D 17/00

(52) U.S. Cl. 442/59; 510/405; 510/218; 510/285; 510/337

(57) ABSTRACT

A novel class of ionic liquids and methods for their preparation are disclosed. Specifically, these novel ionic liquids can be derived from surfactants, such as betaines, amine oxides. The present invention also relates to compositions containing these novel ionic liquids and method of using the same.

### CROSS REFERENCE TO RELATED APPLICATIONS

This application is a continuation of and claims priority under 35 U.S.C. §120 to U.S. application Ser. No. 11/263,384, filed Oct. 31, 2005, which in turn claims priority under 35 U.S.C. §119(e) from Provisional Application Ser. No. 60/624,056, filed on Nov. 1, 2004.

### FIELD OF THE INVENTION

The present invention relates to a novel class of ionic liquids and methods for their preparation. Specifically, these novel ionic liquids can be derived from amphoteric surfactants, such as betaines and amine oxides. The present invention also relates to compositions containing these novel ionic liquids and method of using the same.

### BACKGROUND OF THE INVENTION

Generally speaking, ionic liquids refer to a specific class of molten salts which are liquid at temperatures of 100° C. or below. Ionic liquids have very low vapor pressure and generate virtually no hazardous vapors. Due to the charged species comprising the ionic fluids, they provide a highly polar medium.

In recent years, there is much interest in this class of novel materials. Ionic liquids have been extensively evaluated as environmental-friendly or “green” alternatives to conventional organic solvents for a broad range of organic synthetic applications. In addition, ionic liquids have also been used in organic synthesis applications as catalysts. Conventional ionic liquids for a wide range of chemical processes are described in “Ionic Liquid” by J. D. Holbrey and K. R. Seddon, and in Clean Products and Processes, Vol. 1, pp. 223-236 (1999). Other examples of ionic liquids are described in U.S. Pat. No. 6,048,388; U.S. Pat. No. 5,827,602; U.S. Patent Publications: US 2003/915735A1; US 2004/0007693A1; US 2004/0035293A1; and PCT publications: WO 02/26701; WO 03/074494; WO 03/022812; WO 04/016570.

Furthermore, ionic liquids have also been found useful in chemical separation and extraction, as described, for example, in WO 02/074718.

Ionic liquids also have applications in electrochemistry, for example, in fuel cells, electrodeposition processes and other electrochemical applications.

Additionally, ionic liquids have been shown to be effective in applications where water-based chemistry can be problematic (for example, applications involving proton transfer or nucleophilicity), or in applications where certain coordination chemistry could have a damaging effect on the substrates involved.

Moreover, ionic liquids have found applications in consumer product formulations and industrial product formulations for surface treating, air treating, cleaning and other benefits, as described in WO 04/003120.

It is desirable to develop new classes of ionic liquids by converting certain conventional solid or semi-solid actives used in consumer or industrial product formulations into ionic liquids. Thus, the ionic liquids can be used as replacements for the traditional actives, such as surfactants, and are easier to incorporate into the formulations. Moreover, the ionic nature and/or fluidity of these novel ionic liquids provide additional advantages, such as improved soil removal capability, lower viscosity of the formulation, and higher concentration of the active functionalities can be incorporated.

It is also desirable to develop new classes of ionic liquids with advantageous properties. For example, new classes of water immiscible ionic liquids having surfactant functionalities can be used in conventional aqueous based formulations to provide enhanced interactions with certain soils on the surface being treated and to extract or separate soils from the aqueous cleaning medium.

### SUMMARY OF THE INVENTION

The present invention relates to an ionic compound comprising an anion and a cation selected from the group consisting of:

(a) amine oxide cation having the formula:

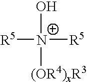

wherein R³ is an C₈₋₂₂ alkyl, C₈₋₂₂ hydroxyalkyl, C₈₋₂₂ alkyl phenyl group, and mixtures thereof; R⁴ is an C₂₋₃ alkylene or C₂₋₃ hydroxyalkylene group or mixtures thereof; x is from 0 to about 3; and each R⁵ is independently an C₁₋₃ alkyl or C₁₋₃ hydroxyalkyl group or a polyethylene oxide group containing an average of from about 1 to about 3 ethylene oxide groups; or the R⁵ groups are attached to each other, through an oxygen or nitrogen atom, to form a ring structure;

(b) betaine having the formula:

R—N⁽⁺⁾(R¹)₂—R²COOH
wherein R is selected from the group consisting of C10-C22 alkyl, C10-C22 alkyl aryl and C10-C22 aryl alkyl, all of which are optionally interrupted by amido or ether linkages; each R¹ is a C1-C3 alkyl group; and R² is a C1-C6 alkylene group;
   and

(c) mixtures thereof.

The present invention also relates to a composition comprising the above ionic compounds, and method of using the same to treat hard and soft surfaces.

### DETAILED DESCRIPTION OF THE INVENTION

“Consumer product” as used herein refers to a material that is used by a user (i.e., a consumer) in, on or around their person, house (such as kitchen surfaces, bathroom surfaces, carpets, floors, windows, minors and countertops), car (such as automobile interiors, automobile exteriors, metal surfaces and windshields), other personal or household articles (such as dishware, fabrics, cookware, utensils, tableware and glassware), and air surrounding the user. “Consumer product composition” may also include the material used by institutional users (such as hotels, restaurants, offices) or by service providers (such as commercial dry cleaners and janitorial services).

“Industrial product” as used herein refers to a material that is used in a commercial process of making an article. Nonlimiting examples include degreasing compositions for degreasing articles, such as metals; and textile treating compositions for processing and/or finishing textiles into fabric articles, such as garments, draperies.

“Treating” as used herein refers to a composition or a process for cleaning, refreshing or maintaining the target surface or air. For example, “refreshing” includes the processes of removing the wrinkled or worn appearance from a fabric article, or imparting a pleasant odor to a fabric article, air, a soft surface or a hard surface.

“Surface”, “target surface” or “treated surface” as used herein refers to an inanimate, non-biological surface. Nonlimiting examples of such surfaces are found in soft surfaces such as fabrics, fabric articles, textiles, fibers; and hard surfaces such as dishware, cookware, utensils, glassware, countertops, kitchen surfaces, bathroom surfaces, floors, windows, car interior and exterior, metal, and combinations thereof.

“Derived from” as used herein refers to ionic compounds of interest may be mixed or made from original materials such that the ionic compounds may be present in simple mixtures of the original materials, or mixtures of the original materials and the reaction or decomposition products thereof, or mixtures of reaction or decomposition products.

“Hydrophilic ionic compound” or “water miscible ionic compound” as used herein refers to ionic compound that is partially or wholly miscible with water, i.e. it is capable of forming a visually homogenous or transparent mixture with water according to the Water Miscibility Test described herein.

“Hydrophobic ionic compounds” or “water immiscible ionic compounds” as used herein refers to ionic compounds that are relatively immiscible with water.

The present invention relates to novel ionic liquids that are derived from compounds that have been used as surfactants in detergent formulations for laundry, dish washing and hard surface cleaning. By reacting or mixing various surfactants commonly used in detergent formulations with properly chosen counterions, these surfactants can be converted into ionic compounds having different characteristics.

For example, the surfactant-derived ionic compounds are hydrophobic or water immiscible. In other examples, the surfactant-derived ionic compounds are water miscible. In some embodiments, the surfactant derived ionic compounds are liquids at temperatures of about 100° C. or below. That is, these ionic compounds exhibit a first order transition or a melting point of about 100° C. or below, as measured by Differential Scanning Calorimetry (DSC). In other embodiments, the surfactant derived ionic compounds do not exhibit a melting point but are “flowable” at a temperature of about 100° C. or below. As used herein, the term “flowable” means the ionic compound exhibits a viscosity of less than about 10,000 cps at a temperature of about 100° C., preferably at a temperature range from about 20° C. to about 80° C. and more preferably from about 20° C. to about 60° C. Due to these differences in the ionic compounds, the term “ionic liquid” as used herein is meant to include all ionic compounds exhibiting one or more of the above characteristics. For certain applications, it is desirable to have ionic compounds that are liquids or “flowable” at temperatures ranging from about 20 to about 80° C., i.e., the typical fabric or dish washing temperatures.

It should be understood that the terms “ionic liquid”, “ionic compound”, and “IL” encompass ionic liquids, ionic liquid composites, and mixtures (or cocktails) of ionic liquids. The ionic liquid can comprise an anionic IL component and a cationic IL component. When the ionic liquid is in its liquid form, these components may freely associate with one another (i.e., in a scramble). As used herein, the term “cocktail of ionic liquids” refers to a mixture of two or more, preferably at least three, different and charged IL components, wherein at least one IL component is cationic and at least one IL component is anionic. Thus, the pairing of three cationic and anionic IL components in a cocktail would result in at least two different ionic liquids. The cocktails of ionic liquids may be prepared either by mixing individual ionic liquids having different IL components, or by preparing them via combinatorial chemistry. Such combinations and their preparation are discussed in further detail in US 2004/0077519A1 and US 2004/0097755A1. As used herein, the term “ionic liquid composite” refers to a mixture of a salt (which can be solid at room temperature) with a proton donor Z (which can be a liquid or a solid) as described in the references immediately above. Upon mixing, these components turn into a liquid at about 100° C. or less, and the mixture behaves like an ionic liquid.

### Surfactant-Derived Ionic Liquids

Nonlimiting examples of surfactant-derived ionic liquids of the present invention comprise cations such as:

(a) amine oxide cations

Suitable amine oxide cations have the following formula:

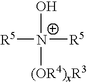

wherein R³ is an C₈₋₂₂ alkyl, C₈₋₂₂ hydroxyalkyl, C₈₋₂₂ alkyl phenyl group, and mixtures thereof; R⁴ is an C₂₋₃ alkylene or C₂₋₃ hydroxyalkylene group or mixtures thereof; x is from 0 to about 3; and each R⁵ is independently an C₁₋₃ alkyl or C₁₋₃ hydroxyalkyl group or a polyethylene oxide group containing an average of from about 1 to about 3 ethylene oxide groups; the R⁵ groups may be attached to each other, e.g., through an oxygen or nitrogen atom, to form a ring structure; other exemplary amine oxide cations include C₁₀-C₁₈, C₁₀, C₁₀-C₁₂, and C₁₂-C₁₄ alkyl dimethyl amine oxide cations, and C₈-C₁₂ alkoxy ethyl dihydroxy ethyl amine oxide cations.

In some embodiments, the amine oxide cations comprise one C₈₋₁₈ alkyl moiety and two moieties independently selected from the group consisting of C₁₋₃ alkyl groups and C₁₋₃ hydroxyalkyl groups.

(b) Betaines

Suitable betaines have the general formula:

R—N⁽⁺⁾(R¹)₂—R²COOH
wherein R is selected from the group consisting of alkyl groups containing from about 10 to about 22 carbon atoms, preferably from about 12 to about 18 carbon atoms, alkyl aryl and aryl alkyl groups containing a similar number of carbon atoms with a benzene ring treated as equivalent to about 2 carbon atoms, and all of which may optionally be interrupted by amido or ether linkages; each R¹ is an alkyl group containing from 1 to about 3 carbon atoms; and R² is an alkylene group containing from 1 to about 6 carbon atoms.

In some embodiments, betaines include dodecyl dimethyl betaine, acetyl dimethyl betaine, dodecyl amidopropyl dimethyl betaine, tetradecyl dimethyl betaine, tetradecyl amidopropyl dimethyl betaine, dodecyl dimethyl ammonium hexanoate, and amidoalkylbetaines; which are disclosed in U.S. Pat. No. 3,950,417; U.S. Pat. No. 4,137,191; U.S. Pat. No. 4,375,421; and GB 2,103,236.

The surfactant-derived cations described above can be paired with one or more of the following anions:
(1) Alkyl sulfates (AS), alkoxy sulfates and alkyl alkoxy sulfates, wherein the alkyl or alkoxy is linear, branched or mixtures thereof; furthermore, the attachment of the sulfate group to the alkyl chain can be terminal on the alkyl chain (AS), internal on the alkyl chain (SAS) or mixtures thereof: nonlimiting examples include linear C₁₀-C₂₀ alkyl sulfates having formula:

CH₃(CH₂)_{x+y}CH₂OSO₃⁻M⁺
wherein x+y is an integer of at least 8, preferably at least about 10; M⁺ is a cation selected from the cations of the ionic liquids as described in detail herein; or linear C₁₀-C₂₀ secondary alkyl sulfates having formula:

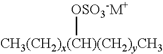

wherein x+y is an integer of at least 7, preferably at least about 9; x or y can be 0, M⁺ is a cation selected from the cations of the ionic liquids as described in detail herein; or C10-C20 secondary alkyl ethoxy sulfates having formula:

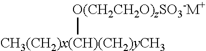

wherein x+y is an integer of at least 7, preferably at least about 9; x or y can be 0, M⁺ is a cation selected from the cations of the ionic liquids as described in detail herein; nonlimiting examples of alkoxy sulfate include sulfated derivatives of commercially available alkoxy copolymers, such as Pluronics® (from BASF);
(2) Mono- and di-esters of sulfosuccinates: non-limiting examples include saturated and unsaturated C₁₂₋₁₈ monoester sulfosuccinates, such as lauryl sulfosuccinate available as Mackanate LO-100® (from The McIntyre Group); saturated and unsaturated C₆-C₁₂ diester sulfosuccinates, such as dioctyl ester sulfosuccinate available as Aerosol OT® (from Cytec Industires, Inc.);
(3) Methyl ester sulfonates (MES);
(4) Alkyl aryl sulfonates, nonlimiting examples include tosylate, alkyl aryl sulfonates having linear or branched, saturated or unsaturated C₈-C₁₄ alkyls; alkyl benzene sulfonates (LAS) such as C₁₁-C₁₈ alkyl benzene sulfonates; sulfonates of benzene, cumene, toluene, xylene, t-butylbenzene, di-isopropylbenzene, or isopropylbenzene; naphthalene sulfonates and C₆₋₁₄ alkyl naphthalene sulfonates, such as Petro® (from Akzo Nobel Surface Chemistry); sulfonates of petroleum, such as Monalube 605® (from Uniqema);
(5) Alkyl glycerol ether sulfonates having 8 to 22 carbon atoms in the alkyl moiety;
(6) Diphenyl ether (bis-phenyl) derivatives: Nonlimiting examples include Triclosan (2,4,4′-trichloro-2′-hydroxydiphenyl ether) and Diclosan (4,4′-dichloro-2-hydroxydiphenyl ether), both are available as Irgasan® from Ciba Specialty Chemicals;
(7) Linear or cyclic carboxylates: nonlimiting examples include citrate, lactate, tartarate, succinate, alkylene succinate, maleate, gluconate, formate, cinnamate, benzoate, acetate, salicylate, phthalate, aspartate, adipate, acetyl salicylate, 3-methyl salicylate, 4-hydroxy isophthalate, dihydroxyfumarate, 1,2,4-benzene tricarboxylate, pentanoate and mixtures thereof;
(8) Alkyl oxyalkylene carboxylates: nonlimiting examples include C₁₀-C₁₈ alkyl alkoxy carboxylates preferably comprising 1-5 ethoxy units;
(9) Alkyl diphenyl oxide monosulfonate: nonlimiting examples include alkyl diphenyl oxide monosulfonate of the general formula:

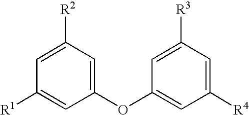

wherein R¹ is C₁₀-C₁₈ linear or branched alkyl; R² and R³ are independently SO₃⁻ or H, provided at least one of R² or R³ is not hydrogen; R⁴ is R¹ or H; suitable alkyl diphenyl oxide monosulfonates are available as DOWFAX® from Dow Chemical and as POLY-TERGENT® from Olin Corp.;
(10) Mid-chain branched alkyl sulfates (HSAS), mid-chain branched alkyl aryl sulfonates (MLAS) and mid-chain branched alkyl polyoxyalkylene sulfates; nonlimiting examples of MLAS are disclosed in U.S. Pat. No. 6,596,680; U.S. Pat. No. 6,593,285; and U.S. Pat. No. 6,202,303;
(11) Alpha olefin sulfonates (AOS) and paraffin sulfonates, nonlimiting examples include C₁₀₋₂₂ alpha-olefin sulfonates, available as Bio Terge AS-40® from Stepan Company;
(12) Alkyl phosphate esters, nonlimiting examples include C₈₋₂₂ alkyl phosphates, available as Emphos CS® and Emphos TS-230® from Akzo Nobel Surface Chemistry LLC;
(13) Sarcosinates having the general formula RCON(CH₃)CH₂CO₂⁻, wherein R is an alkyl from about C₈₋₂₀; nonlimiting examples include ammonium lauroyl sarcosinate, available as Hamposyl AL-30® from Dow Chemicals and sodium oleoyl sarcosinate, available as Hamposyl O® from Dow Chemical;
(14) Taurates, such as C₈₋₂₂ alkyl taurates, available as sodium coco methyl tauride or Geropon TC® from Rhodia, Inc.;
(15) Sulfated and sulfonated oils and fatty acids, linear or branched, such as those sulfates or sulfonates derived from potassium coconut oil soap available as Norfox 1101® from Norman, Fox & Co. and Potassium oleate from Chemron Corp.;
(16) Alkyl phenol ethoxy sulfates and sulfonates, such as C₈₋₁₄ alkyl phenol ethoxy sulfates and sulfonates; nonlimiting examples include sulfated nonylphenol ethoxylate available as Triton XN-45S® from Dow Chemical;
(17) Fatty acid ester sulfonates having the formula:

R₁—CH(SO₃⁻)CO₂R₂
wherein R₁ is linear or branched C₈ to C₁₈ alkyl, and R₂ is linear or branched C₁ to C₆ alkyl;
(18) Sweetener derived anions: saccharinate and acesulfamate;

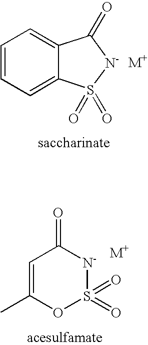

wherein M+ is a cation selected from the cations of the ionic liquids as described herein;
(19) Ethoxylated amide sulfates; sodium tripolyphosphate (STPP); dihydrogen phosphate; fluoroalkyl sulfonate; bis-(alkylsulfonyl) amine; bis-(fluoroalkylsulfonyl)amide; (fluoroalkylsulfonyl)(fluoroalkylcarbonyl)amide; bis(arylsulfonyl)amide; carbonate; tetrafluorborate (BF₄⁻); hexafluorophosphate (PF₆⁻);
(20) Anionic bleach activators having the general formula:

R¹—CO—O—C₆H₄—R²
wherein R¹ is C₈-C₁₈ alkyl, C₈-C₁₈ amino alkyl, or mixtures thereof, and R² is sulfonate or carbonate; nonlimiting examples such as:

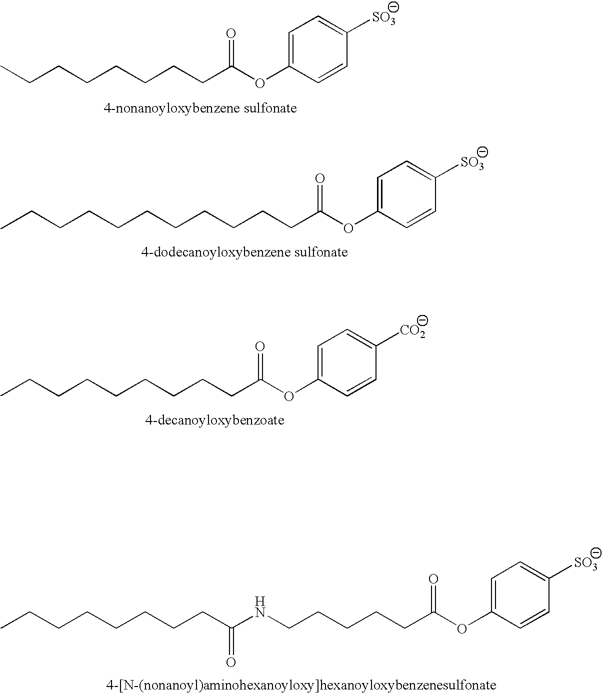

are disclosed in U.S. Pat. No. 5,891,838; U.S. Pat. No. 6,448,430; U.S. Pat. No. 5,891,838; U.S. Pat. No. 6,159,919; U.S. Pat. No. 6,448,430; U.S. Pat. No. 5,843,879; U.S. Pat. No. 6,548,467.

The wide selection of cations provides the advantage of customizing the ionic liquids of the present invention for specific application or desired benefit. These anions can be selected and mixed with the surfactant derived cations described herein such that properties of the resulting ionic liquids can be customized. For example, water immiscible ionic liquids can be particularly useful in removing certain soils from the surface being treated and in extracting/separating soils from the aqueous medium.

In some embodiments, water immiscible ionic liquids comprise cations having the formulae:

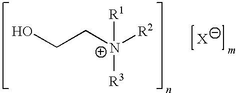

wherein R¹-R³ are selected from among the group consisting of linear or branched, substituted or unsubstituted, alkyl, aryl, alkoxyalkyl, alkylenearyl hydroxyalkyl, or haloalkyl; X is an anion such as those described hereinabove; m and n are chosen to provide electronic neutrality; further wherein the ionic liquids are water immiscible when at least one of R¹-R³ is C12 or higher; or at least two of R¹-R³ are C10 or higher; or all three of R¹-R³ are C6 or higher; and X is an anion containing at least a C₈-C₂₂ alkyl group.

In some embodiments, the water immiscible ionic liquids comprise a cation selected from the group consisting of trimethyloctyl ammonium cation, triisooctylmethyl ammonium cation, tetrahexyl ammonium cation, tetraoctyl ammonium cation, and mixtures thereof.

In some embodiments, the water immiscible ionic liquids comprise amine oxide cations and those anions described hereinabove.

In some embodiments, the water immiscible ionic liquids comprise betaine cations and those anions described hereinabove.

### Ionic Liquids Applications

The ionic liquids of the present invention may be used in various consumer, institutional or industrial products, including but not limited to a laundry detergent, a dish cleaning detergent, a hard surface cleaning composition, a dry cleaning composition, an air care composition, a car care composition, a textile treating composition, or an industrial degreasing composition.

Without wishing to be bound by theory, it is believed that the fundamental chemical and/or physical properties on ionic liquids can be used advantageously in the surface or air treating compositions. In one aspect, ionic liquids have a high solubilizing ability, due to their high polarity and charge density; thus, ionic liquids can be an effective solvent for soils. Therefore, compositions containing ionic liquids exhibit enhanced soil removal ability, compared to similar compositions without the ionic liquids. In another aspect, the functional groups and counterions of the ionic liquids can be varied such that the resulting ionic liquids are “tuned” to the characteristics of the target soil or surface. For example, the functional groups can be selected such that the resulting ionic liquids have the desired degree of hydrophilicity or hydrophobicity to interact more strongly or preferentially with the target soil or surface. The mechanisms by which ionic liquids can effectively interact with soil or substrates include, but are not limited to, charge transfer, ion exchange, van der Waals forces, and hydrogen bonding. In yet another aspect, the effective solvating property of the ionic liquids enables them to dissolve certain polymeric materials, which are soluble in few if any solvent media. Examples of such hard-to-dissolve polymers include, but are not limited to, biofilms, baked-on or cooked-on soils, polymerized soils, and the like.

In fabric cleaning and/or treating applications, ionic liquids provide high polarity without the detrimental effects of water. For example, water can cause damages to certain fabrics; the damage includes shrinkage, dye loss, shape loss, and wrinkles, etc.

Additionally, the nucleophilic and protic nature of water can lead to undesirable effects when formulating compositions intended for treating fabrics or similar soft surfaces. For example, water's ability to swell and hydrogen bond to cellulose can lead to increased abrasion and shrinkage of fabrics. Ionic liquids can be tailored or selected to be non-nucleophilic and/or aprotic such that they would not have these adverse effects on cellulosic fibers or fabrics.

In still another aspect, the ionic liquids are non-volatile and nonflammable, and have high thermal stability; as such, they are especially suitable for use in surface or air treating compositions for both safety and aesthetic reasons. It is often undesirable to have chemical vapors or low flash points associated with compositions used in a consumer, industrial or institutional setting. It is also undesirable to have compositions that will leave unsightly streaks on surfaces treated by them. Commonly used organic cleaning solvents tend to have chemical vapors that may be toxic, flammable, or malodorous. Other commonly used compositions may leave unsightly or streaky residue on the treated surfaces, thus, they need to be removed (e.g., by wiping, rinsing, and the like) from the surfaces after application. In contrast, ionic liquids have essentially no vapor pressure (i.e., no detectable vapor pressure at or near room temperature); compositions using ionic liquids as the solvents or the active ingredients would avoid the problems associated with chemical vapors, thus, are highly advantageous. Additionally, such compositions can be used as a leave-on product and produce aesthetically pleasing results on the treated surfaces.

Thus, the unique and customizable physical and chemical properties allow ionic liquids to overcome several problems that persist in prior art compositions for treating soft or hard surfaces or air.

Accordingly, the present invention also relates to compositions, consumer products, and industrial products comprising the surfactant-derived ionic liquids, and the methods of using the same in following applications: dish/food cleaning, home care (kitchen/bath), biofilm removal, dry-cleaning (home & commercial), laundry (pretreatment, cleaning, and fabric care), textile processing & finishing, car care (interior and exterior), industrial degreasing, and air care.

The ionic liquid may be used in these applications or products as a pure solvent (i.e. as a pure, undiluted ionic liquid); as a co-solvent in conjunction with water or other organic solvents; or as an active where the continuous phase is water or another solvent (e.g. linear or cyclic siloxanes, halocarbons). Various adjunct ingredients known in the art may be incorporated into such compositions. In certain embodiments, water and/or solvent may be present in the composition at least about 0.01% or at least about 1% or at least about 10%, and less than about 90% or less than about 70% or less than about 50% by weight of the composition.

The ionic liquid compositions may be formulated in the form of liquid, gel, paste, foam, or solid. When the composition is in the solid form, it can be further processed into granules, powders, tablets, or bars.

The ionic liquid compositions may also comprise adjunct ingredients commonly used in air or surface treating compositions. When present, an adjunct ingredient may comprise from about 0.01 to about 10%, preferably from about 0.1 to about 5% by weight of the composition.

Suitable adjunct ingredients may be selected from the group consisting of enzymes, bleaches, surfactants, perfumes, co-solvents, cleaning agents, antibacterial agents, antistatic agents, brighteners, dye fixatives, dye abrasion inhibitors, anti-crocking agents, wrinkle reduction agents, wrinkle resistance agents, soil release polymers, sunscreen agents, anti-fade agents, particulate builders (e.g., silica, zeolites, phosphates), polymeric builders (e.g., polyacrylates, poly(acrylic-maeic) copolymers), sudsing agents, composition malodor control agents, dyes, colorants, speckles, pH buffers, waterproofing agents, soil repellency agents, and mixtures thereof.

Examples of suitable adjunct ingredients are disclosed in U.S. Pat. No. 6,488,943, Beerse et al.; U.S. Pat. No. 6,514,932, Hubesch et al.; U.S. Pat. No. 6,548,470, Buzzaccarini et al.; U.S. Pat. No. 6,482,793, Gordon et al.; U.S. Pat. No. 5,545,350, Baker et al.; U.S. Pat. No. 6,083,899, Baker et al.; U.S. Pat. No. 6,156,722, Panandiker et al.; U.S. Pat. No. 6,573,234, Sivik et al.; U.S. Pat. No. 6,525,012, Price et al.; U.S. Pat. No. 6,551,986, Littig et al.; U.S. Pat. No. 6,566,323, Littig et al.; U.S. Pat. No. 6,090,767, Jackson et al.; and/or U.S. Pat. No. 6,420,326, Maile et al.

In some embodiments, such as laundry or dishwashing, ionic liquid compositions may be applied to the fabric or dish directly, or may be diluted with water to form a wash liquor, which contacts the fabric or dish. In other embodiments, the ionic liquid compositions may be in the form of a liquid, which can be applied to the target surface as a liquid spray, as an aerosol spray, or as a pour-on liquid, which can be poured onto the target surface directly or indirectly via a substrate such as a fibrous web substrate (made by woven, nonwoven or knitted technologies), a pulp-based substrate (made by air-felt or wet-laid technologies, including paper towels, tissues), a sponge, or a foam substrate. Another mode of use would be to incorporate ionic liquid compositions into or onto these substrates (e.g. impregnated in a wipe or a mitten), which would alleviate residue problems in those applications where complete dry down is needed.

The ionic liquid-containing compositions may be formulated in the form of liquid, gel, paste, foam, or solid. When the composition is in the solid form, it can be further processed into granules, powders, tablets, or bars. The composition may be employed as a component of another cleaning product, for example by application to an absorbent substrate to provide a wipe for use in various applications. Any suitable absorbent substrate may be employed, including woven or nonwoven fibrous webs and/or foam webs. It is preferred that such an absorbent substrate should have sufficient wet strength to hold an effective amount of the composition according to the present invention to facilitate cleaning. The ionic liquid-containing composition can also be included in unit dose products, which typically employ a composition of the present invention in a unit dose package comprising a water soluble polymer film. Exemplary unit dose package are disclosed in U.S. Pat. No. 4,973,416; U.S. Pat. No. 6,451,750; U.S. Pat. No. 6,448,212; and US 2003/0,054,966A1.

### Example 1

### Preparation of N-Dodecyl-N,N-Dimethylamine N-Oxide Ionic Liquid

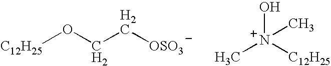

To a solution of N-dodecyl-N,N-dimethylamine N-Oxide (5 g, 23.2 mmole) and hydrobromic acid (3.9 g of 48% aqueous solution, 23.2 mmole) in 20 ml de-ionized water is added a solution of sodium dodecylethoxy sulfate (7.7 g, 23.2 mmole) in 20 ml de-ionized water. After stirring 30 minutes at room temperature, the stirring is stopped and the solution separates into two layers by gravity. The upper organic layer is collected in a separatory funnel. It is dissolved in 25 ml methylene chloride. After standing for a few minutes, a small aqueous layer separates from the organic layer. The lower organic layer is collected, dried over anhydrous sodium sulfate for 5 minutes, filtered and concentrated on a rotary evaporator. The resultant material is stirred at 60 degrees C. and 0.1 mm Hg for 3 hours to remove residual solvent. The final product is a waxy solid at room temperature.

### Example 2

### Preparation of N-Dodecylamidopropyl-N,N-Dimethyl-N-Carboxymethylammonium Dodecylethoxysulfate Ionic Liquid

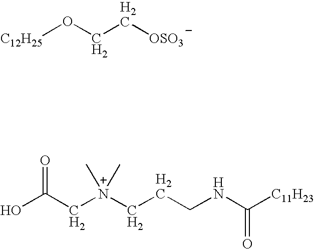

To a solution of N-(dodecylamidopropyl)-N,N-dimethyl-N-carboxymethylammonium (5 g, 14.6 mmole) and hydrobromic acid (2.5 g of 48% aqueous solution, 14.6 mmole) in 20 ml de-ionized water is added a solution of sodium dodecylethoxy sulfate (4.9 g, 14.6 mmole) in 20 ml de-ionized water. After stirring 30 minutes at room temperature, the stirring is stopped and the solution separates into two layers by gravity. The upper organic layer is collected in a separatory funnel. It is dissolved in 25 ml methylene chloride. After standing for a few minutes a small aqueous layer separates from the organic layer. The lower organic layer is collected, dried over anhydrous sodium sulfate for 5 minutes, filtered and concentrated on a rotary evaporator. The resultant material is stirred at 60 degrees C. and 0.1 mm Hg for 3 hours to remove residual solvent. The final product is a waxy solid at room temperature.

### Example 3

### Preparation of N-Decyl-N,N-Dimethylamine N-Oxide 2,4,8-Trimethylnonyl-6-(Triethoxysulfate) Ionic Liquid

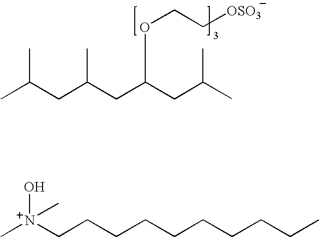

To a solution of N-decyl-N,N-dimethylamine N-Oxide (5 g, 24.8 mmole) and hydrobromic acid (4.2 g of 48% aqueous solution, 24.9 mmole) in 20 ml de-ionized water is added a solution of sodium 2,4,8-trimethylnonyl-6-(triethoxysulfate) (10.5 g, 24.9 mmole) in 30 ml de-ionized water. After stirring 30 minutes at room temperature, the stirring is stopped and the solution separates into two layers by gravity. The upper organic layer is collected in a separatory funnel. It is dissolved in 25 ml methylene chloride. After standing for a few minutes, a small aqueous layer separates from the organic layer. The lower organic layer is collected, dried over anhydrous sodium sulfate for 5 minutes, filtered and concentrated on a rotary evaporator. The resultant material is stirred at 60 degrees C. and 0.1 mm Hg for 3 hours to remove residual solvent. The final product is a clear viscous oil at room temperature.

Other surfactant-derived ionic liquids of the present invention can be made by these and similar processes.

### Characterization of the Ionic Liquids

The structures of the ionic liquids of the present invention are characterized by NMR (nuclear magnetic resonance). The melting temperatures of the ionic liquids are characterized by DSC (differential scanning calorimetry) from about 20° C. to about 100° C. at a scan rate of 10° C. per minute on heating cycles and 5° C. per minute on cooling cycles.

### Water Miscibility Test

The water miscibility of an ionic liquid is measured by the following water miscibility test. A mixture of 0.5 g ionic liquid and 4.5 g de-ionized water are sonicated in a Bransonic Ultrasonic Bath (model# 1210R-MTH, 50/60 Hz, 117 volts, 1.3 AMPS) according to manufacture's specifications for 1.5 hours. Thereafter, if a homogenous transparent system results within 15 minutes of standing without agitation, then the ionic liquid is water miscible.

### Examples

Nonlimiting examples of the surfactant-derived ionic liquids of the present invention shown below illustrate that the properties of the ionic liquids can be customized.

| | | | Liquid at | Melting | |
|---|---|---|---|---|---|
| | Amphoteric | | Room | Point | Water |
| Example | Surfactant | Counter ion | Temp? | Range | Miscible? |
| 1 | N-dodecyl-N,N- | 2,4,8-trimethylnonyl-6- | Yes | Noneⁱ | No |
| | dimethylamine | triethoxysulfate | | | |
| | N-oxide | | | | |
| 2 | N-dodecyl-N,N- | dedecylethoxysulfate | No | 39 to 49° C. | No |
| | dimethylamine | | | | |
| | N-oxide | | | | |

ⁱThis ionic liquid is a liquid at temperature range scanned, hence no observable melting point on DSC.

The following are nonlimiting examples of consumer product compositions containing ionic liquids of the present invention.

| | Composition Examples | | | | | |
|---|---|---|---|---|---|---|
| | 4 | 5 | 6 | 7 | 8 | 9 |
| Ionic Liquid 1^{a} | — | 5 | — | 2 | — | — |
| Ionic Liquid 2^{b} | 10 | — | — | — | 60 | — |
| Ionic Liquid 3^{c} | — | — | 20 | — | — | 90 |
| Aesthetic | 1 | 1 | 1 | 1 | 1 | 1 |
| Agents¹ | | | | | | |
| Enzymes² | 2 | — | — | 1 | — | — |
| Adjuncts³ | 40 | 30 | 10 | 25 | 5 | 5 |
| Co-solvent⁴ | — | 5 | 2 | — | 15 | 2 |
| Water | balance | balance | balance | balance | balance | balance |

^{a}N-dodecyl-N,N-dimethylamine N-oxide dodecylethoxysulfate.
^{b}N-(dodecylamidopropyl)-N,N-dimethyl-N-carboxymethylammonium.
^{c}N-decyl-N,N-dimethylamine-N-oxide 2,4,8-trimethylnonyl-6-(triethoxysulfate).
¹aesthetic agents may be selected from among the group consisting of dyes, colorants, speckles, perfumes and mixtures thereof.
²enzymes may be selected from among the group consisting of proteases, amylases, lipases, and mixtures thereof.
³adjuncts may be selected from among the group consisting of surfactants, enzymes, bleaching agents, preservatives and mixtures thereof.
⁴co-solvents may be selected from among the group consisting of ethanol, isopropanol, propylene glycol, and mixtures thereof

All documents cited in the Detailed Description of the Invention are, in relevant part, incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A water immiscible ionic liquid comprising an anion and a cation selected from the group consisting of:
(a) amine oxide cation having the formula: 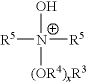
wherein R³ is an C₈₋₂₂ alkyl, C₈₋₂₂ hydroxyalkyl, C₈₋₂₂ alkyl phenyl group, and mixtures thereof; R⁴ is an C₂₋₃ alkylene or C₂₋₃ hydroxyalkylene group or mixtures thereof; x is from 0 to about 3; and each R⁵ is independently an C₁₋₃ alkyl or C₁₋₃ hydroxyalkyl group or a polyethylene oxide group containing an average of from about 1 to about 3 ethylene oxide groups; or the R⁵ groups are attached to each other, through an oxygen or nitrogen atom, to form a ring structure;
(b) betaine having the formula:
R—N⁽⁻⁾(R¹)₂—R²COOH
R is selected from the group consisting of C₁₀-C₂₂ alkyl, C₁₀-C₂₂ alkyl aryl and C₁₀-C₂₂ aryl alkyl, all of which are optionally interrupted by amido or ether linkages; each R¹ is a C₁-C₃ alkyl group; and R² is a C₁-C₆ alkylene group; and
(c) mixtures thereof.

2. The ionic liquid of claim 1 wherein the anion is selected from the group consisting of:
(1) alkyl sulfates, alkoxy sulfates, alkyl alkoxy sulfates, wherein the alkyl or alkoxy groups is linear, branched, or mixtures thereof;
(2) mono- and di-esters of sulfosuccinates;
(3) methyl ester sulfonates;
(4) alkylaryl sulfonates;
(5) alkyl glycerol ether sulfonates containing C8-C22 alkyl groups;
(6) diphenyl ether (bis-phenyl) derivatives;
(7) linear or cyclic carboxylates;
(8) alkyl oxyalkylene carboxylates;
(9) monosulfonate of diphenyl sulfonates;
(10) mid-chain branched alkyl sulfonates, alkylaryl sulfonates, and alkyl polyoxyalkylene sulfonates;
(11) alpha olefin sulfonates, paraffin sulfonates;
(12) alkyl phosphate esters;
(13) sarcosinates having the general formula RCON(CH₃)CH₂CO₂⁻, wherein R is a C8-C20 alkyl;
(14) C8-C22 alkyl taurates;
(15) sulfated and sulfonated oils and fatty acids which are linear or branched;
(16) alkyl phenol ethoxy sulfates or sulfonates;
(17) fatty acid ester sulfonates having the formula R¹—CH(SO₃⁻)CO₂R²; wherein R¹ is linear or branched C₈ to C₁₈ alkyl, and R² is linear or branched C₁ to C₆ alkyl;
(18) saccahrinates, acesulfamates;
(19) ethoxylated amide sulfates; sodium tripolyphosphate (STPP); dihydrogen phosphate; fluoroalkyl sulfonate; bis-(alkylsulfonyl)amine; bis-(fluoroalkylsulfonyl)amide; (fluoroalkylsulfonyl)(fluoroalkylcarbonyl) amide; bis(arylsulfonyl)amide; carbonate; tetrafluorborate (BF₄⁻); hexafluorophosphate (PF₆⁻);
(20) anionic bleach activators having the general formula:
R¹—CO—O—C₆H₄—R²
wherein R¹ is C₈-C₁₈ alkyl, C₈-C₁₈ amino alkyl, or mixtures thereof, and R² is sulfonate or carbonate; and
(21) mixtures thereof.

3. A composition comprising a water immiscible ionic liquid comprising a cation and an ionic liquid forming anion, the cation is selected from the group consisting of:
(b) amine oxide cation having the formula: 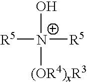
wherein R³ is an C₈₋₂₂ alkyl, C₈₋₂₂ hydroxyalkyl, C₈₋₂₂ alkyl phenyl group, and mixtures thereof; R⁴ is an C₂₋₃ alkylene or C₂₋₃ hydroxyalkylene group or mixtures thereof; x is from 0 to about 3; and each R⁵ is independently an C₁₋₃ alkyl or C₁₋₃ hydroxyalkyl group or a polyethylene oxide group containing an average of from about 1 to about 3 ethylene oxide groups; or the R⁵ groups are attached to each other, through an oxygen or nitrogen atom, to form a ring structure;
(b) betaine having the formula:
R—N⁽⁺⁾(R¹)₂—R²COOH
R is selected from the group consisting of C₁₀-C₂₂ alkyl, C₁₀-C₂₂ alkyl aryl and C₁₀-C₂₂ aryl alkyl, all of which are optionally interrupted by amido or ether linkages; each R¹ is a C₁-C₃ alkyl group; and R² is a C₁-C₆ alkylene group; and
(c) mixtures thereof.

4. The composition according to claim 1 wherein the anion is selected from the group consisting of alkyl sulfates, alkoxy sulfates, alkyl alkoxy sulfates, monoesters of sulfosuccinates, diesters of sulfosuccinates, methyl ester sulfonates, alkylaryl sulfonates, alkyl glycerol ether sulfonates, diphenyl ethers, linear carboxylates, cyclic carboxylates, alkyl oxyalkylene carboxylates, alkyl diphenyl oxide monosulfonate, mid-chain branched alkyl sulfates (HSAS), mid-chain branched alkylaryl sulfonates (MLAS) and mid-chain branched alkyl polyoxyalkylene sulfates, alpha-olefin sulfonates, paraffin sulfonates, alkyl phosphate esters, sarcosinates, taurates, sulfated oils and fatty acids, sulfonated oils and fatty acids, alkyl phenol ethoxy sulfates, alkyl phenol ethoxy sulfonates, fatty acid ester sulfonates, sweetener-derived anions, ethoxylated amide sulfates, sodium tripolyphosphate; dihydrogen phosphate; fluoroalkyl sulfonate; bis-(alkylsulfonyl)amine; bis-(fluoroalkylsulfonyl)amide; (fluoroalkylsulfonyl)(fluoroalkylcarbonyl)amide; bis(arylsulfonyl)amide; carbonate; tetrafluorborate (BF₄⁻); hexafluorophosphate (PF₆⁻); and anionic bleach activators having the general formula: R₁—CO—O—C₆H₄R₂, wherein R₁ is C8-C18 alkyl, C8-C18 amino alkyl, or mixtures thereof, and R₂ is sulfonate or carbonate, and mixtures thereof.

5. The composition according to claim 4 further comprising an adjunct ingredient selected from the group consisting of cleaning agents, perfumes, enzymes, bleaching agents, surfactants, aesthetic agents, water, co-solvents, and mixtures thereof.

6. The composition of claim 5 wherein the composition is a laundry detergent, a dish cleaning detergent, a hard surface cleaning composition, a dry cleaning composition, an air care composition, a car care composition, a textile treating composition, or an industrial degreasing composition.

7. The composition according to claim 6 wherein the laundry detergent is selected from the group consisting of heavy duty laundry detergents, pretreating compositions, and combinations thereof.

8. A method for treating a target surface comprising the step of: contacting a target surface with a water immiscible ionic liquid; wherein the ionic liquid comprises a cation and an ionic liquid forming anion, the cation is selected from the group consisting of:
(a) amine oxide cation having the formula: 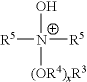
wherein R³ is an C₈₋₂₂ alkyl, C₈₋₂₂ hydroxyalkyl, C₈₋₂₂ alkyl phenyl group, and mixtures thereof; R⁴ is an C₂₋₃ alkylene or C₂₋₃ hydroxyalkylene group or mixtures thereof; x is from 0 to about 3; and each R⁵ is independently an C₁₋₃ alkyl or C₁₋₃ hydroxyalkyl group or a polyethylene oxide group containing an average of from about 1 to about 3 ethylene oxide groups; or the R⁵ groups are attached to each other, through an oxygen or nitrogen atom, to form a ring structure;
(b) betaine having the formula:
R—N⁽⁺⁾(R¹)₂—R²COOH
R is selected from the group consisting of C₁₀-C₂₂ alkyl, C₁₀-C₂₂ alkyl aryl and C₁₀-C₂₂ aryl alkyl, all of which are optionally interrupted by amido or ether linkages; each R¹ is a C₁-C₃ alkyl group; and R² is a C₁-C₆ alkylene group; and
(c) mixtures thereof.

9. The method according to claim 8 wherein the anion is selected from the group consisting of alkyl sulfates, alkoxy sulfates, alkyl alkoxy sulfates, monoesters of sulfosuccinates, diesters of sulfosuccinates, methyl ester sulfonates, alkylaryl sulfonates, alkyl glycerol ether sulfonates, diphenyl ethers, linear carboxylates, cyclic carboxylates, alkyl oxyalkylene carboxylates, alkyl diphenyl oxide monosulfonate, mid-chain branched alkyl sulfates (HSAS), mid-chain branched alkylaryl sulfonates (MLAS) and mid-chain branched alkyl polyoxyalkylene sulfates, alpha-olefin sulfonates, paraffin sulfonates, alkyl phosphate esters, sarcosinates, taurates, sulfated oils and fatty acids, sulfonated oils and fatty acids, alkyl phenol ethoxy sulfates, alkyl phenol ethoxy sulfonates, fatty acid ester sulfonates, sweetener-derived anions, ethoxylated amide sulfates, sodium tripolyphosphate; dihydrogen phosphate; fluoroalkyl sulfonate; bis-(alkylsulfonyl) amine; bis-(fluoroalkylsulfonyl)amide; (fluoro alkyl sulfonyl)(fluoroalkylcarbonyl)amide; bis(arylsulfonyl)amide; carbonate; tetrafluorborate (BF₄⁻); hexafluorophosphate (PF₆⁻); and anionic bleach activators having the general formula: R₁—CO—O—C₆H₄—R₂, wherein R₁ is C8-C18 alkyl, C8-C18 amino alkyl, or mixtures thereof, and R₂ is sulfonate or carbonate, and mixtures thereof.

10. The method according to claim 9 wherein the target surface is selected from the group consisting of soft surfaces, hard surfaces, and combinations thereof.

11. The method according to claim 10 wherein the soft surfaces are selected from the group consisting of fabric articles, textiles, fibers, and combinations thereof; and the hard surfaces are selected from the group consisting of dishware, cookware, utensils, glassware, countertops, bathroom surfaces, kitchen surfaces, floors, windows, car interiors, car exteriors, metal and mixtures thereof.

12. A surface treated by the method according to claim 8.

13. An article of manufacture comprising a substrate and a water immiscible ionic liquid associated with the substrate, wherein the ionic liquid comprises a cation and an ionic liquid forming anion, the cation is selected from the group consisting of:
(a) amine oxide cation having the formula: 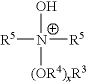
wherein R³ is an C₈₋₂₂ alkyl, C₈₋₂₂ hydroxyalkyl, C₈₋₂₂ alkyl phenyl group, and mixtures thereof; R⁴ is an C₂₋₃ alkylene or C₂₋₃ hydroxyalkylene group or mixtures thereof; x is from 0 to about 3; and each R⁵ is an C₁₋₃ alkyl or C₁₋₃ hydroxyalkyl group or a polyethylene oxide group containing an average of from about 1 to about 3 ethylene oxide groups; or the R⁵ groups are attached to each other, through an oxygen or nitrogen atom, to form a ring structure;
(b) betaine having the formula:
R—N⁽⁺⁾(R¹)₂—R²COOH
wherein R is selected from the group consisting of C₁₀-C₂₂ alkyl, C₁₀-C₂₂ alkyl aryl and C₁₀-C₂₂ aryl alkyl, all of which are optionally interrupted by amido or ether linkages; each R¹ is a C₁-C₃ alkyl group; and R² is a C₁-C₆ alkylene group; and
(c) mixtures thereof.

14. The article according to claim 13 wherein the anion is selected from the group consisting of alkyl sulfates, alkoxy sulfates, alkyl alkoxy sulfates, monoesters of sulfosuccinates, diesters of sulfosuccinates, methyl ester sulfonates, alkylaryl sulfonates, alkyl glycerol ether sulfonates, diphenyl ethers, linear carboxylates, cyclic carboxylates, alkyl oxyalkylene carboxylates, alkyl diphenyl oxide monosulfonate, mid-chain branched alkyl sulfates (HSAS), mid-chain branched alkylaryl sulfonates (MLAS) and mid-chain branched alkyl polyoxyalkylene sulfates, alpha-olefin sulfonates, paraffin sulfonates, alkyl phosphate esters, sarcosinates, taurates, sulfated oils and fatty acids, sulfonated oils and fatty acids, alkyl phenol ethoxy sulfates, alkyl phenol ethoxy sulfonates, fatty acid ester sulfonates, sweetener-derived anions, ethoxylated amide sulfates, sodium tripolyphosphate; dihydrogen phosphate; fluoroalkyl sulfonate; bis-(alkylsulfonyl)amine; bis-(fluoroalkylsulfonyl)amide; (fluoroalkylsulfonyl)(fluoroalkylcarbonyl)amide; bis(arylsulfonyl)amide; carbonate; tetrafluorborate (BF₄⁻); hexafluorophosphate (PF₆⁻); and anionic bleach activators having the general formula: R₁—CO—O—C₆H₄—R₂, wherein R₁ is C8-C18 alkyl, C8-C18 amino alkyl, or mixtures thereof, and R₂ is sulfonate or carbonate, and mixtures thereof.

15. The article according to claim 14 wherein the substrate is selected from the group consisting of a woven fibrous substrate, a non-woven fibrous substrate, a knitted fibrous substrate, a pulp-based air-felt substrate, a pulp-based wet-laid substrate, a foam, a sponge, and combinations thereof.

16. The article according to claim 14 further comprising an adjunct ingredient selected from the group consisting of cleaning agents, perfumes, enzymes, bleaching agents, surfactants, aesthetic agents, water, co-solvents, and mixtures thereof.
